(19) United States
(12) Patent Application Publication
(10) Pub. No.: US 2009/0050262 A1
(43) Pub. Date: Feb. 26, 2009

(54) Production of Dosing Molds from Active Substance-Containing Melts

(76) Inventors: Jorg Rosenberg, Ellerstadt (DE); Norbert Steiger, Lingenfeld (DE); Harald Hach, Oberotterbach (DE); Jorg Breitenbach, Mannheim (DE)

Correspondence Address: EDWARDS ANGELL PALMER & DODGE LLP, P.O. BOX 55874, BOSTON, MA, 02205, US

(21) Appl. No.: 11/884,521

(22) PCT Filed: Feb. 17, 2006
(86) PCT No.: PCT/EP2006/001475

§ 371 Date: Apr. 17, 2008

(30) Foreign Application Priority Data
Feb. 17, 2005 (EP) 05003457.8

(51) Int. Cl. B32B 37/10

(52) U.S. Cl. 156/245; 156/500

(57) ABSTRACT

Disclosed is a method for producing dosing molds, according to which two separating films (7) are contacted with each other in a defined area, an active substance-containing melt is introduced between the separating films (7) such that a pocket for receiving a portion of the melt is embodied in at least one of the separating films, and the separating films (7) are separated from each other in order to eject the portion. Preferably, a method is disclosed in which the separating films (7) are contacted with each other in the gap of two molding rolls (2, 3) which rotate in opposite directions and are provided with opposite recesses (4, 5) on the surface thereof, and into which the separating films (7) can be pressed when the active substance-containing melt is introduced so as to form pockets. The separating films (7) make it possible to avoid a direct contact between the melt and the rolls (4,5) and thus prevent the melt from adhering to the roll (2, 3). Elastically deformable separating films (7) support the ejection process as a result of the stress thereof being released after leaving the roll gap (2, 3).

The present invention relates to a process for the production of dose forms from an active substance-containing melt.

In the production of dose forms by means of melt extrusion processes in combination with a shaping process such as calendering, a process in which the melt is shaped in the gap between at least two counterrotating shaping rolls to give the desired dose form, it is crucial that the melt does not have any excessive adhesion to the shaping tools, as otherwise demolding is not possible. The terms shaping rolls and calender are used synonymously below.

WO 9707786 describes the use of lipids as excipients in the production of solid pharmaceutical forms by the melt extrusion process. Between 0.1-10% by weight of lipids are added to the extrusion mixture here as a mold release agent.

DE 4446467 describes a process for the production of lenticular tablets by melt calendering. Reference is made in this publication to the fact that shaping rolls which are provided with a mold release agent can be used. A suitable mold release agent is, for example, a silicone lacquer.

EP 0358105 describes a process for the shaping of extrudate compositions. In this process, two elastic belts having hollows lying opposite one another which determine the tablet shape are used.

WO 9619963 describes a process for the production of coated tablets by melt calendering, in which the active substance-containing melt is introduced into the calender shaping rolls between two films of the coating material.

SU 1824158 describes a device for the shaping of viscoplastic praline compositions. The device comprises a filling funnel having two chambers. Below the filling funnel is arranged a shaping roll with cells for receiving and shaping the praline composition. The shaping roll is covered by an elastic belt. A first composition is pressed into the cells under pressure from the first chamber, the elastic belt being partially deflected. The shaping roll rotates further and from the second chamber a second composition is pressed into the cells, the elastic belt being maximally deflected. On further rotation, the molded praline composition article is ejected from the cells by the elasticity of the belt.

JP 02 063699 A discloses a pressure granulation device having two counterrotating rolls and two elastic films which, at least in the contact area of the rolls, lie on the rolls. Hollows are provided on the surface of the rolls or of the films. A powder is compressed between the rolls and is given the shape of the hollows.

Neither SU 1824158 nor JP 02 063699 A relate to the shaping of melts, i.e. of sub-stances which are plastic at elevated temperature and which solidify on cooling.

The invention is based on the object of specifying a universally usable process which allows the shaping of active substance-containing melts without the problems due to adhesion of the melt to and/or in the molding tool occurring here.

The present invention relates to a process in which two separating films are brought together in a defined area, an active substance-containing melt is introduced between the separating films such that in at least one of the separating films a pocket for receiving a portion of the melt is formed and the separating films are separated from one another in order to demold the portion. In order that the portion of the melt is adequately solidified and on demolding essentially retains the assumed shape, the separating film is expediently brought into contact with a heat sink, at least in the area of the pocket, with the side facing away from the melt. By means of the separating film, heat is extracted from the melt and the melt solidifies. Moreover, the thermal stress of the separating film is decreased and its lifetime is increased.

The entering melt customarily has a temperature of more than 70° C., usually more than 80° C., e.g. 80 to 180° C. In general, a difference between the melt to be introduced and the heat sink of at least 30° C., in particular at least 40° C., particularly preferably at least 50° C., is maintained.

In a preferred embodiment, the separating films are brought together in the gap between two counterrotating shaping rolls, of which at least one has hollows into which the separating film can be pressed for the formation of pockets. Particularly preferably, both shaping rolls have hollows on their surface opposite to one another, into which the separating films can be pressed for the formation of pockets.

In the shaping process, the separating film is deformed by the melt introduced into the trough-shaped space between the shaping rolls and pressed onto the surfaces of the hollows. The separating film here prevents direct contact of the melt with the roll surface, such that any adhesion of the melt to the surface of the roll can be excluded.

The shaping rolls moreover act as heat sinks and for this purpose are manufactured from a readily heat-conducting material, preferably a metal, such as stainless steel or nonferrous metal alloys. The heat dissipation can take place passively by radiation of heat or by active cooling of the shaping rolls, e.g. by circulation of a cooling agent through bores in the interior of the shaping rolls. The separating film makes contact with the surface of the shaping roll only if the separating film is pressed completely into the hollow of the shaping roll and the pocket formed is filled completely with melt. Only then does noticeable cooling and solidification of the melt begin. Premature solidification, which could lead to incomplete filling of the hollows with melt, is largely avoided. In this way, shaped articles are obtained which are very uniform with respect to their shape and their mass.

The thickness of the separating films used is in general in the range from 0.05 to 1.6 mm, preferably 0.1 to 1 mm and particularly preferably 0.1 to 0.5 mm.

In a preferred embodiment, the separating films are made from an elastically deformable material, as here, due to the relaxation of the separating film on leaving the roll gap, a force occurs which presses the molded article out of the cavity, thus virtually ejects the molded article.

Should the melt solidify slowly and still be very soft and plastic here when leaving the rolls, on account of the stress occurring when using elastic separating films undesired deformation of the shaped articles can occur. In these cases, the use of separating films having a low or negligible elasticity is preferred. The formation of the pockets in the separating films can be favored by a slight softening of the films at the temperatures in the roll gap. This softening point can be adjusted via the content of plasticizers in the separating films.

If the films are made of one elastomer, these have a tensile strength measured according to DIN EN ISO 527-1 in the range from 3 to 40 Mpa, preferably 7 to 30 Mpa. The elongation at break according to DIN EN ISO 527-1 is at least 200%, preferably at least 400%.

Of course, it is also possible to choose two separating films of different material and/or of different thickness and/or different plasticizer content for the process. Usually, however, two identical separating films are preferred.

The separating films can be guided through the roll gap by unwinding the film from a roll and, after guiding it through the roll gap, winding it onto a second roll. For the cleaning of melt residues from the film, the separating film can be guided through a stripper or a cleaning bath downstream of the roll.

In a preferred embodiment, the separating films are in each case closed to give an endless belt, which makes possible continuous process control.

As an endless belt, the separating film can lie here on the generated surface of the shaping rolls at the peripheries of the shaping roll hollows.

A variant of the process consists in guiding one or both separating films outside the roll gap at a distance to the shaping rolls and guiding it/them into the gap via adjustable guiding rolls. In the case of the use of elastic belts, tension screws attached to the guide rolls moreover allow an exact adjustment of the thickness of the film in the calender gap and thus the selective exertion of influence on the ejection forces with which the molded articles are pressed out of the cavities of the shaping roll.

The invention moreover relates to a device having a mixing and plasticizing unit for the formation of an active substance-containing melt, and shaping means which consist of two shaping rolls which have at least one hollow for receiving an active substance-containing melt. The device is distinguished in that the hollow comprises a separating film which is reversibly transposable from a resting position to a deflected position by introduction of the active substance-containing melt into the hollow.

The material of the separating films can be selected from the elastomers and/or water-insoluble thermoplastic polymers.

Elastomers are used, such as silicone elastomers, acrylate rubber, polyesterurethane rubber, brominated butyl rubber, polybutadiene, chlorinated butyl rubber, chlorinated polyethylene, epichlorohydrin homo-/copolymer, polychloropropene, sulfated polyethylene, ethylene acrylate rubber, ethylene-propylene terpolymer, ethylene-propylene copolymer, polyetherurethane rubber, ethylene-vinyl acetate copolymer, fluorinated rubber, fluorosilicone rubber, hydrogenated nitrile rubber, butyl rubber, dimethylpolysiloxane, nitrile rubber (with a low, medium or high ACN content, natural rubber, thioplast, polyfluorophosphazenes, polynorbonenes, styrene-butadiene rubber and carboxyl group-containing nitrile rubbers or mixtures thereof.

Elastomers are preferred which are accepted as product-contacting materials in pharmaceutical production processes, e.g. silicones. These silicone materials can be pre-pared by addition crosslinking, condensation crosslinking or free radical crosslinking processes. Further preferred materials are natural rubber and synthetic rubber, natural rubber being particularly preferred.

Preferred separating film materials have one or more, preferably all, of the following properties:

Natural rubber

| Property | Unit | preferably | particularly preferably |
|---|---|---|---|
| Hardness | Shore A | 35-90 | 45-75 |
| Tear resistance | [N/mm²] | 15-30 | 15-30 |
| Elongation at break | [%] | 100-900 | 200-900 |
| Tear-propagation | [N/mm] | ≧3.2 | |
| resistance | | | |

Synthetic rubber

| Property | Unit | Preferably | particularly preferably |
|---|---|---|---|
| Hardness | Shore A | 35-95 | 45-75 |
| Tear resistance | [N/mm²] | 6-50 | 8-50 |
| Elongation at break | [%] | 100-800 | 200-800 |
| Tear-propagation | [N/mm] | ≧25 | |
| resistance | | | |

Silicones

| Property | Unit | Preferably | particularly preferably |
|---|---|---|---|
| Hardness | Shore A | 5-80 | 45-75 |
| Tear resistance | [N/mm²] | 2.4-9.5 | 6-9.5 |
| Elongation at break | [%] | 100-600 | 200-600 |
| Tear-propagation | [N/mm] | 4.4-52.5 | |
| resistance | | | |

Water-insoluble thermoplastics which can be used are: polyolefins and polyolefin derivatives or copolymers (e.g. polyethylene, polypropylene, polyisobutylene, poly-4-methylpentene and vinyl acetate, vinyl alcohol, acrylic, methacrylic copolymers), vinyl polymers (e.g. polystyrene and polystyrene ter- and block polymers, e.g. copolymers of styrene, acrylonitrile and butadiene, polyvinyl chloride and copolymers, e.g. copolymers of vinyl chloride and vinyl acetate, methacrylate or acrylonitrile), polyvinyl acetate, polyvinyl alcohol, polyvinyl methyl ether, fluoropolymers such as polytetrafluoroethylene, polyvinyldiene fluoride, polyvinyl fluoride, polyacrylates and methacrylates such as, for example, polyacrylonitrile, polymethyl methacrylate, polyoxymethylene homo- and copolymers, polyamides and polyamide copolymers, polycarbonates and polycarbonate copolymers, polyethylene terephthalate, polysulfones and polyarylsulfones, polyaryl ether ketones, polyimides, polyurethanes. The thermoplastic polymers mentioned can optionally also be present in mixtures (polymer blends). The prerequisite for use is that the active substance-containing melt does not adhere to the thermoplastic film and does not firmly bond with it.

Thermoplastic polymers are thus preferred whose softening point lies above the temperature of the active substance-containing melt when they enter into the calender gap. It is also preferred here to guide the film through the calender gap as an endless belt, since no film waste results thereby.

By means of choice of profiled films, e.g. dimpled films, the geometries of the dose forms can moreover be further modified. A film is also possible which on its surface contains the structures which in each case fill out some of the hollows of the shaping rolls and thus lead to selective changes of the geometry of the dose forms.

The dose forms are produced starting from a mixture which contains one or more pharmaceutical active substances and one or more excipients and which become pasty to semifluid and therefore extrudable by melting or softening of at least one component.

These are, in particular, mixtures which contain pharmacologically acceptable polymers, for example

homopolymers and copolymers of N-vinyllactams, in particular homopolymers and copolymers of N-vinylpyrrolidone, e.g. polyvinylpyrrolidone (PVP), copolymers of N-vinylpyrrolidone and vinyl acetate or vinyl propionate,

cellulose esters and cellulose ethers, in particular methylcellulose and ethylcellulose, hydroxyalkylcelluloses, in particular hydroxypropylcellulose, hydroxyalkylalkylcelluloses, in particular hydroxypropylmethylcellulose, cellulose phthalate or succinate, in particular cellulose acetate phthalate and hydroxypropylmethylcellulose phthalate, hydroxypropylmethylcellulose succinate or hydroxypropylmethylcellulose acetate succinate,

high molecular weight polyalkylene oxides such as polyethylene oxide and polypropylene oxide and copolymers of ethylene oxide and propylene oxide,

polyacrylates and polymethacrylates such as methacrylic acid/ethyl acrylate copolymers, methacrylic acid/methyl methacrylate copolymers, butyl methacrylate/2-dimethylaminoethyl methacrylate copolymers, poly(hydroxyalkyl acrylates), poly(hydroxyalkyl methacrylates),

polyacrylamides,

vinyl acetate polymers such as copolymers of vinyl acetate and crotonic acid, partially hydrolyzed polyvinyl acetate (also designated as partially saponified polyvinyl alcohol), polyvinyl alcohol,

oligo- and polysaccharides such as carrageenans, galactomannans and xanthans, or mixtures of one or more thereof.

Of these, homo- or copolymers of vinylpyrrolidone are particularly preferred, e.g. polyvinylpyrrolidone having K values according to Fikentscher of 12 to 100, preferably 17 to 30, or copolymers of 30 to 70% by weight of N-vinylpyrrolidone (VP) and 70 to 30% by weight of vinyl acetate (VA), such as, for example, a copolymer of 60% by weight of VP and 40% by weight of VA.

Of course, mixtures of the polymers mentioned can also be employed.

Active substances within the meaning of the invention are to be understood as meaning all substances having a desired physiological action on the human or animal body or plants. They are, in particular, pharmaceutical active substances. The amount of active substance per dose unit can vary within wide limits. They are usually chosen such that they suffice for the achievement of the desired action. Active substance combinations can also be employed. Active substances within the meaning of the invention are also vitamins and minerals. The vitamins include the vitamins of the A group, the B group, among which in addition to B₁, B₂, B₆ and B₁₂ and nicotinic acid and nicotinamide also compounds with vitamin B are understood, such as, for example, adenine, choline, pantothenic acid, biotin, adenylic acid, folic acid, orotic acid, pangamic acid, carnitine, p-aminobenzoic acid, myoinositol and lipoic acid and also vitamin C, vitamins of the D group, E group, F group, H group, I and J group, K group and P group. Active substances within the meaning of the invention also include peptide therapeutics and proteins. Plant treatment compositions include, for example, vinclozolin, epoxiconazole and quinmerac.

The process according to the invention is suitable, for example, for processing the following active substances:

acebutolol, acetylcysteine, acetylsalicylic acid, aciclovir, albrazolam, alfacalcidol, allantoin, allopurinol, ambroxole, amikacin, amiloride, aminoacetic acid, amiodarone, amitriptyline, amlodipine, amoxicillin, ampicillin, ascorbic acid, aspartame, astemizole, atenolol, beclomethasone, benserazide, benzalkonium hydrochloride, benzocaine, benzoic acid, betamethasone, bezafibrate, biotin, biperiden, bisoprolol, bromazepam, bromhexine, bromocriptine, budesonide, bufexamac, buflomedil, buspirone, caffeine, camphor, captopril, carbamazepine, carbidopa, carboplatin, cefachlor, cefalexin, cefatroxil, cefazolin, cefixime, cefotaxime, ceftazidime, ceftriaxone, cefuroxime, celediline, chloramphenicol, chlorhexidine, chlorpheniramine, chlorthalidone, choline, cyclosporin, cilastatin, cimetidine, ciprofloxacin, cisapride, cisplatin, clarithromycin, clavulanic acid, clomibramine, clonazepam, clonidine, clotrimazole, codeine, cholestyramine, cromoglycic acid, cyanocobalamine, cyproterone, desogestrel, dexamethasone, dexpanthenol, dextromethorphan, dextropropoxyphene, diazepam, diclofenac, digoxin, dihydrocodeine, dihydroergotamine, dihydroergotoxine, diltiazem, diphenhydramine, dipyridamol, dipyrone, diisopyramide, domperidone, dopamine, doxycycline, enalapril, ephedrine, epinephrine, ergocalciferol, ergotamine, erythromycin, estradiol, ethinylestradiol, etoposide, eucalyptus globulus, famotidine, felodipine, fenofibrate, fenofibric acid, fenoterol, fentanyl, flavine mononucleotide, fluconazole, flunarizine, fluorouracil, fluoxetine, flurbiprofen, furosemide, gallopamil, gemfibrozil, gentamicin, gingko biloba, glibenclamide, glipizide, clozapine, glycyrrhiza glabra, griseofulvin, guaifenesin, haloperidol, heparin, hyaluronic acid, hydrochlorothiazide, hydrocodone, hydrocortisone, hydromorphone, ipratropium hydroxide, ibuprofen, imipenem, indomethacin, insulin, iohexyl, iopamidol, isosorbide dinitrate, isosorbide mononitrate, isotretinoin, itraconazole, ketotifen, ketoconazole, ketoprofen, ketorolac, labatalone, lactulose, lecithin, levocarnitine, levodopa, levoglutamid, levonorgestrel, levothyroxine, lidocaine, lipase, lipramin, lisinopril, loperamide, lopinavir, lorazepam, lovastatin, medroxyprogesterone, menthol, methotrexate, methyldopa, methylprednisolone, metoclopramide, metoprolol, miconazole, midazolam, minocycline, minoxidil, misoprostol, morphine, multivitamin mixtures and combinations and mineral salts, N-methylephedrine, naftidrofuryl, naproxen, neomycin, nicardipine, nicergoline, nicotinamide, nicotine, nicotinic acid, nifedipine, nimodipine, nitrazepam, nitrendipine, nizatidine, norethisterone, norfloxacin, norgestrel, nortriptyline, nystatin, ofloxacin, omeprazole, ondansetrone, pancreatin, panthenol, panto thenic acid, paracetamol, penicillin G, penicillin V, phenobarbital, phenoxifylline, phenoxymethylpenicillin, phenylephrine, phenylpropanolamine, phenyloin, piroxicam, polymyxin B, povidone-iodine, pravastatin, prazepam, prazosine, prednisolone, prednisone, promocriptine, propafenone, propranolol, proxyphylline, pseudoephedrine, pyridoxine, quinidine, ramipril, ranitidine, reserpine, retinol, riboflavin, rifampicin, ritonavir, rutoside, saccharin, salbutamol, salcatonin, salicylic acid, simvastatin, somatropin, sotalol, spironolactone, sucralfate, sulbactam, sulfamethoxazole, sulfasalazine, sulpiride, tamoxifen, tegafur, teprenone, terazosin, terbutaline, terfenadine, tetracycline, theophylline, thiamine, ticlopidine, timolol, tranexamic acid, tretinoin, triamcinolone acetonide, triamteren, trimethoprim, troxerutin, uracil, valproic acid, vancomycin, verapamil, vitamin E, volinic acid, zidovudine.

The composition can in addition comprise various optional excipients. Such optional excipients are:

plasticizers such as, for example, C₇-C₃₀-alkanols, ethylene glycol, propylene glycol, glycerol, trimethylolpropane, triethylene glycol, butanediols, pentanols, such as pentaerythritol and hexanols, polyalkylene glycols, preferably having a molecular weight of 200 to 1000, such as, for example, polyethylene glycols, polypropylene glycols and polyethylene propylene glycols, silicones, aromatic carboxylic acid esters (e.g. dialkyl phthalates, trimellitic acid esters, benzoic acid esters, terephthalic acid esters) or aliphatic dicarboxylic acid esters (e.g. dialkyl adipates, sebacic acid esters, azelaic acid esters, citric and tartaric acid esters), fatty acid esters, such as glycerol mono-, glycerol di- or glycerol triacetate or sodium diethylsulfosuccinate. If present, the concentration of plasticizer is in general 0.5 to 30, preferably 0.5 to 10% by weight, based on the total weight of polymer and plasticizer. The amount of plasticizer is advantageously at most 30% by weight, based on the total weight of polymer and plasticizer, in order that—in the range of solid forms—storage-stable formulations and dose forms are formed which do not show any cold flow.

Sugar alcohols such as sorbitol, xylitol, mannitol, maltitol; or sugar alcohol derivatives such as isomalt or hydrogenated condensed palatinose such as described in DE 102 62 005.

Solubilizers, such as sorbitan fatty acid esters, polyalkoxylated fatty acid esters, such as, for example, polyalkoxylated glycerides, polyalkoxylated sorbitan fatty acid esters or fatty acid esters of polyalkylene glycols; or polyalkoxylated ethers of fatty alcohols. A fatty acid chain in these compounds usually comprises 8 to 22 carbon atoms. Per molecule, the polyalkylene oxide blocks comprise on average 4 to 50 alkylene oxide units, preferably ethylene oxide units.

Suitable sorbitan fatty acid esters are sorbitan monolaurate, sorbitan monopalmitate, sorbitan monostearate, sorbitan monooleate, sorbitan tristearate, sorbitan trioleate, sorbitan monostearate, sorbitan monolaurate or sorbitan monooleate.

Suitable polyalkoxylated sorbitan fatty acid esters are, for example, polyoxyethylene(20)sorbitan monolaurate, polyoxyethylene(20)sorbitan monopalmitate, polyoxyethylene(20)sorbitan monostearate, polyoxyethylene(20)sorbitan monooleate, polyoxyethylene(20)sorbitan tristearate, polyoxyethylene(20)sorbitan trioleate, polyoxyethylene(4)sorbitan monostearate, polyoxyethylene(4)sorbitan monolaurate or polyoxyethylene(4)sorbitan monooleate.

Suitable polyalkoxylated glycerides are obtained, for example, by alkoxylation of natural or hydrogenated glycerides or by transesterification of natural or hydrogenated glycerides with polyalkylene glycols. Commercially available examples are polyoxyethyleneglycerol ricinoleate 35, polyoxyethyleneglycerol trihydroxystearate 40 (Cremophor® RH40, BASF AG) and also polyalkoxylated glycerides such as are obtainable from Gattefosse under the trade names Gelucire® and Labrafil®, e.g. Gelucire®44/14 (lauroyl macrogol 32 glycerides, prepared by transesterification of hydrogenated palm kernel oil with PEG 1500), Gelucire® 50/13 (stearoyl macrogol 32 glycerides, prepared by transesterification of hydrogenated palm oil with PEG 1500) or Labrafil M1944 CS (oleoyl macrogol 6 glycerides, prepared by transesterification of apricot kernel oil with PEG 300).

A suitable fatty acid ester of polyalkylene glycols is, for example, PEG 660-hydroxystearic acid (polyglycol ester of 12-hydroxystearic acid (70 mol %) with 30 mol % ethylene glycol).

Suitable polyalkoxylated ethers of fatty alcohols are, for example, macrogol 6 cetylstearyl ether or macrogol 25 cetylstearyl ether.

Solubilizers are typically additionally used in the powder mixture in an amount of from 0.1 to 15% by weight, preferably 0.5 to 10% by weight.

Disintegrants, such as crosslinked polyvinylpyrrolidone and crosslinked sodium carboxymethylcellulose.

Extenders or fillers, such as lactose, cellulose, silicates or silicic acid,

lubricants, such as magnesium stearate and calcium stearate, sodium stearylfumarate,

colorants, such as azo dyes, organic or inorganic pigments or dyes of natural origin,

stabilizers, such as antioxidants, light stabilizers, hydroperoxide destroyers, free radical scavengers, stabilizers against microbial attack.

Expediently, the components or some of the components of the melt are mixed to give a powder mixture before warming. The mixing of the components to give the powder mixture is carried out in customary mixers, such as plowshare mixers, shaking or gravity mixers and the like.

The warming of the powder mixture is carried out in a mixing and plasticizing unit customary for this purpose. Heatable extruders or kneaders, such as mixing kneader reactors (e.g. ORP, CRP, AP, DTB from List or Reactotherm from Krauss-Maffei or Ko-Kneter from Buss), double trough kneaders (trough mixers) and plunger kneaders (internal mixers) or rotor/stator systems (e.g. Dispax from IKA) are particularly suitable. The residence time of the composition in the extruder is preferably less than 5 minutes, in particular less than 3 minutes.

The extruders employed can be single screw machines, combing screw machines or alternatively multiwave extruders, in particular twin screw extruders, rotating in the same sense or in the opposite sense and optionally equipped with kneader disks. Twin screw extruders rotating in the same sense are particularly preferred.

Depending on its design, the extruder or kneader is charged continuously or batchwise in a customary manner. The powder mixture is preferably introduced in a free supply, e.g. via a differential proportioning weigher.

The use of continuously operating kneaders and extruders is preferred. Here, the pulverulent mixture of the polymer and of the active substance is introduced into an oblong extruder housing at an inlet end; the mixture is warmed in order to obtain a melt; the melt is moved through the extruder housing to an outlet end of the extruder housing; and an adequate counterpressure is produced in the extruder housing in order that the melt emerges from an outlet end of the extruder housing as a continuous extrudate.

The composition obtained is subsequently subjected according to the invention to a shaping. Here, a large number of shapes, depending on the tool and type of shaping, can be produced.

Under certain circumstances, these shapes can also be ground to give powders and then compressed to give tablets in a customary manner. In this case, tableting excipients such as silicic acid, calcium hydrogenphosphate, lactose, microcrystalline cellulose, starch or magnesium stearate can additionally be used.

The shaping rolls which can be used in the context of the invention for the shaping of the melt can be cooled or heated in a manner known per se, and the optimum surface temperature of the shaping roll for the respective processing process can be adjusted in this manner.

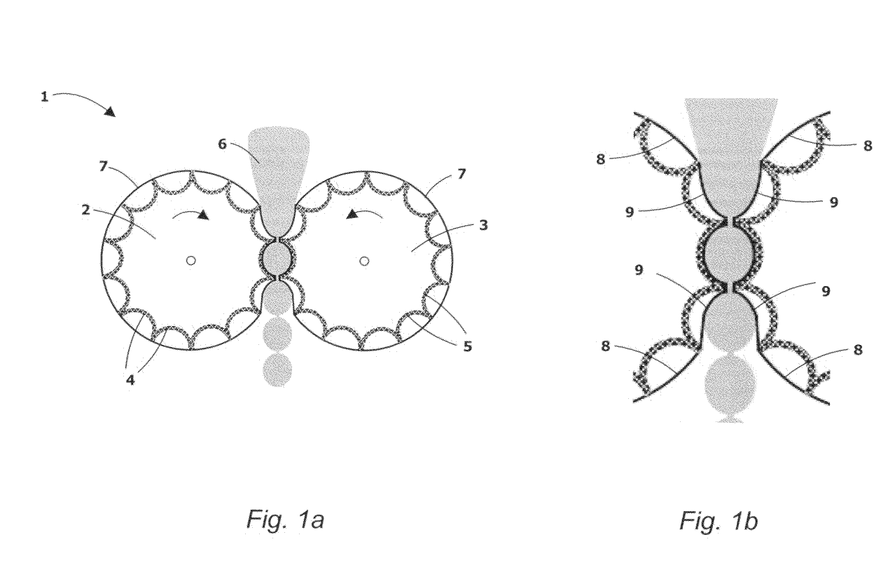

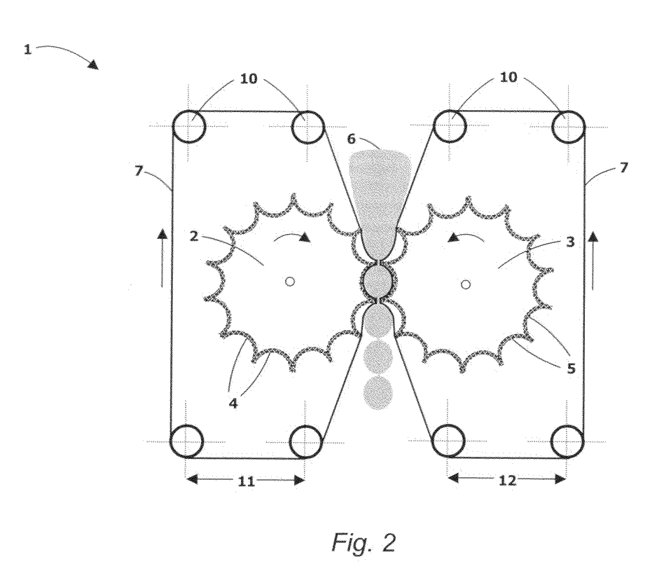

The invention is illustrated in more detail by means of FIGS. 1 and 2 and by the examples below.

FIG. 1a shows a device 1 suitable for carrying out the process according to the invention having counterrotating shaping rolls 2 and 3. The shaping rolls 2 and 3 have hollows 4 and 5 on their surface. A separating film 7 lies on the generated surface of the shaping rolls 2 and 3. On introducing an active substance-containing melt 6 between the shaping rolls 2 and 3, the separating film 7 in the roll gap is pressed into the hollows 4 and 5. After leaving the roll gap, the portions of the melt 6 are demolded.

FIG. 1b is an enlarged section of the gap between the shaping rolls 2 and 3 from FIG. 1a and shows the separating film 7 in its resting position 8 and its deflected position 9.

FIG. 2 shows a further device 1 suitable for carrying out the invention having counterrotating shaping rolls 2 and 3. The shaping rolls 2 and 3 have hollows 4 and 5 on their surface. Adjustable guiding rolls 10 allow the separating films 7 to be guided outside the roll gap at a distance to the shaping rolls 2 and 3. Adjusting screws 11 and 12 (not shown in FIG. 2) attached to the guide rolls 10 allow the distance of the guide rolls 10 to be varied and thus the tension of the separating film 7, when using elastic belts, an accurate adjustment of the thickness of the separating film 7 in the roll gap to be set.

### EXAMPLES

### Example 1

A mixture comprising 50% by weight of verapamil hydrochloride, 32% by weight of hydroxypropylcellulose (Klucel EF, Aqualon) and 18% by weight of hydroxypropylmethylcellulose (Methocel K4M; Colorcon) was extruded in a twin screw extruder rotating in the same sense at a screw speed of 80 rpm and a melt product temperature of 110-120° C. to give a homogeneous extrudate melt. Directly after emergence from the extruder head, the melt arrived between a pair of counterrotating shaping rolls, the shaping rolls in each case having hollows on their surface, with the aid of which it was possible to shape tablets directly from the melt in the roll gap. The shaping rolls were covered with an annular elastomer film, which had been cut out of the cuff area of a rubber glove (Duo-Nit, material: latex mix, film thickness: 0.4 mm). In the unstretched state, this elastomer ring had a slightly smaller diameter than the shaping rolls and therefore sat firmly on the shaping roll surface in a slightly extended state. At a shaping roll temperature of 10° C., it was possible using this process to produce oblong tablets of approximately 1000 mg weight directly from the active substance-containing melt. No problems at all occurred with sticking of the melt in the cavities of the shaping rolls.

### Example 2

### Comparative Example

The procedure was carried out as in Example 1, but without use of the elastomer film located on the rolls. The melt adhered too strongly to the calender roll surfaces, i.e. demolding of the tablets was not possible.

### Example 3

The procedure was carried out as indicated in Example 1, but using a mixture consisting of 50% by weight of verapamil hydrochloride, 40% by weight of hydroxypropylcellulose (Klucel EF, Aqualon) and 10% by weight of hydroxypropylmethylcellulose (Methocel K100M; Colorcon). Calendering was carried out using an elastomer ring (elastomer film from the cuff area of a rubber glove, Berner, cytostatic rubber glove BI-4021, material: natural latex, film thickness: 0.26 mm). No problems at all occurred with sticking of the melt in the cavities of the shaping rolls.

### Example 4

### Comparative Example

The procedure was carried out as in Example 3, but without use of the elastomer film located on the rolls. The melt adhered too strongly to the calender roll surfaces, i.e. demolding of the tablets was not possible.

### Example 5

The procedure was carried out as indicated in Example 1, but using a mixture consisting of 55% by weight of hydroxypropylcellulose (Klucel EF, Aqualon) and 45% by weight of mannitol (Merck). Calendering was carried out using an elastomer ring (elastomer film from the cuff area of a rubber glove; Reichelt Chemie-Technik, Thomastat-HSR-2020 15 MIL black gloves, material: soft plastic, film thickness: 0.15 mm). No problems at all occurred with sticking of the melt in the cavities of the shaping rolls.

### Example 6

### Comparative Example

The procedure was as in Example 5, but without use of the elastomer film located on the rolls. The melt adhered too strongly to the calender roll surfaces, i.e. demolding of the tablets was not possible.

### Example 7

A mixture comprising 40% by weight of ibuprofen, 20% by weight of sodium carbonate, 10.2% by weight of isomaltol (Isomalt F), 23.8% by weight of polyvinylpyrrolidone (Kollidon K30, BASF), 5% by weight of crosslinked polyvinylpyrrolidone (Kollidon Cl, BASF), 1% by weight of Aerosil 200 was extruded in a twin screw extruder rotating in the same sense at a screw speed of 100 rpm and a melt product temperature of 120-130° C. to give a homogeneous extrudate melt. After emergence from the extruder head, the melt arrived directly between a pair of counterrotating shaping rolls, the shaping rolls in each case having hollows on their surface, with the aid of which it was possible to form tablets directly from the melt in the roll gap. When using the elastomer film indicated in Example 1, the tablets could be readily demolded. No problems at all occurred with sticking of the melt in the cavities of the shaping rolls.

### Example 8

### Comparative Example

The procedure was carried out as in Example 7, but without use of the elastomer film located on the rolls. The melt adhered too strongly to the calender roll surfaces, i.e. demolding of the tablets was not possible.

1. A process for producing dose forms, comprising:
i. bring together two separating films in a defined area;
ii. introducing an active substance-containing melt between the separating films, such that in at least one of the separating films a pocket for receiving a portion of the melt is formed; and
iii. separating the separating films from one another in order to demold the portion.

2. The process as claimed in claim 1, in which the separating film is brought into contact with a heat sink in the area of the pocket with a side of said separating film facing away from the melt.

3. The process as claimed in claim 2, in which a temperature difference of at least 30° C. is maintained between the melt to be introduced and the heat sink.

4. The process as claimed in of claim 1, in which the separating films are brought together in a gap between two counterrotating shaping rolls, which have hollows on their surface opposite to one another, into which the separating film can be pressed for the formation of pockets.

5. The process as claimed in claim 1, in which the separating films are in each case closed to give an endless belt.

6. The process as claimed in claim 5, in which the separating films lie on the shaping rolls at the peripheries of the hollows.

7. The process as claimed in claim 1, in which the separating films have a thickness of 0.05 to 1.6 mm.

8. The process as claimed in claim 1, in which the separating films are elastically deformable.

9. The process as claimed in claim 8, in which the separating films have a tensile strength according to DIN EN ISO 527-1 of 3 to 40 Mpa.

10. The process as claimed in claim 8, in which the separating films consist of natural rubber, synthetic rubber or silicone elastomers.

11. The process as claimed in claim 1, in which the separating film consists of a water-insoluble thermoplastic polymer.

12. The process as claimed in claim 1, in which at least one of the separating films has a structured surface.

13. A device for the production of dose forms having a mixing and plasticizing unit for the formation of an active substance-containing melt and shaping means, consisting of two shaping rolls, which have at least one hollow for receiving the active substance-containing melt, characterized in that the hollow comprises a separating film, which is reversibly translatable from a resting position to a deflected position by introduction of the active substance-containing melt into the hollow.

14. The device as claimed in claim 13, characterized in that the separating film is adjusted to the shape of the hollow in the deflected position.

15. The device as claimed in of claim 13, characterized in that the separating film is elastically deformable.

16. The device as claimed in claim 13, characterized in that the shaping means comprise two counterrotating shaping rolls, at least one of the shaping rolls having hollows on its surface for receiving the active substance-containing melt.

17. The device as claimed in claim 16, characterized in that both shaping rolls have hollows lying opposite one another on their surfaces.

18. The device as claimed in claim 17, characterized in that the separating films are in each case closed to give an endless belt.

19. The device as claimed in claim 18, characterized in that each shaping roll is surrounded by a separating film.

20. The device as claimed in claim 14, characterized in that the separating film is elastically deformable.
